(19) United States
(12) Patent Application Publication
(10) Pub. No.: US 2017/0356534 A1
(43) Pub. Date: Dec. 14, 2017

(54) COMPACT PLANETARY GEARBOX

(71) Applicant: ZF Friedrichshafen AG, Friedrichshafen (DE)

(72) Inventors: Frank RICHTER, Oberteuringen (DE); Karl BENKLER, Garmisch-Partenkirchen (DE); Marton KURUCZ, Friedrichshafen (DE)

(21) Appl. No.: 15/617,085

(22) Filed: Jun. 8, 2017

(30) Foreign Application Priority Data
Jun. 8, 2016 (DE) 10 2016 210 078.5

(51) Int. Cl. F16H 37/04; F16H 1/28; F16H 57/08; F16H 1/06; F16H 55/17; F16H 57/021

(52) U.S. Cl. CPC F16H 37/041; F16H 55/17; F16H 57/021; F16H 57/082; F16H 1/06; F16H 1/28

(57) ABSTRACT

A transmission having at least one planetary stage (101), at least one spur gear stage (103) and a transmission housing (117). The planetary stage (101) includes a planetary carrier (107) mounted to rotate, one or more planetary gearwheels (109) mounted to rotate on the planetary carrier (107), and a rotatable sun gear (113). The spur gear stage (103) has at least one spur gear (123). The spur gear (123) and the sun gear (113) are rotationally fixedly connected to one another. The transmission housing (117) has at least one spindle (127) and the spur gear (123) is mounted on the spindle (127).

This application claims priority from German patent application serial no. 10 2016 210 078.5 filed Jun. 8, 2016.

### FIELD OF THE INVENTION

The invention concerns a transmission having a driven planetary stage and a downstream spur gear stage.

### BACKGROUND OF THE INVENTION

In transmissions of this type known from the prior art a planetary carrier of the planetary stage, mounted to rotate in a transmission housing, is supported on both sides, i.e. by means of at least two bearings arranged on the two sides of the planetary carrier. A first spur gear of a spur gear stage is driven by a sun gear shaft. The sun gear shaft projects into a recess of the spur gear and is there connected to the spur gear in a rotationally fixed manner by means of entrainment teeth. Like the planetary carrier, the spur gear is mounted to rotate in the transmission housing supported on both sides, i.e. by means of at least two bearings arranged on the two sides of the spur gear. This is problematic since the twofold bearing support of both the planetary carrier and the spur gear takes up axial structural space.

### SUMMARY OF THE INVENTION

The purpose of the present invention is to provide a transmission with improved characteristics. In particular the weight of the transmission should be reduced and the axial space it occupies should be smaller.

This objective is achieved by a transmission according to the claims.

The transmission comprises at least one planetary stage, at least one spur gear stage and a transmission housing. A planetary stage is understood to be an arrangement having a planetary carrier, which is in this case mounted to rotate, one or more planetary gearwheels mounted to rotate on the planetary carrier, a sun gear, in this case mounted to rotate, and a ring gear which in this case is rotationally fixed. Each planetary gearwheel meshes with the sun gear and/or the ring gear.

Analogously, a spur gear stage is understood to be an arrangement having at least one spur gear.

In the present case the spur gear and the sun gear are connected to one another in a rotationally fixed manner. In particular, the sun gear and the spur gear thus have a common rotational axis. Preferably, that axis coincides with a rotational axis of the planetary carrier.

According to the invention, the transmission housing has at least one spindle. A spindle is understood to be a projecting means that serves to hold some other component. The function of the spindle is to support and provide a bearing for the other component.

The spindle of the transmission housing of the transmission according to the invention can be made integrally with the rest of the transmission housing, or fixed detachably in the rest of the transmission housing. Preferably the spindle is screwed into the rest of the transmission housing. In particular, the spindle and the rest of the transmission housing are fixed in such manner that no relative movement is possible between them.

The spur gear is mounted and can rotate on the spindle. Preferably, the spur gear is mounted on the spindle alone, which implies that any forces that act upon the spur gear are transmitted by way of the spindle to the rest of the transmission housing.

Relative to comparable transmissions, the transmission according to the present invention can be made particularly compact in the axial direction. This results in a substantial weigh reduction.

In a preferred further development, the spur gear constitutes a hub. A hub is defined as a means that is pushed onto a shaft, an axle or a spindle. Correspondingly, the spur gear is pushed onto the spindle of the transmission housing in such a manner that the spindle projects at least partially into the hub. Thus, part of the spindle is inside the hub. Between this part of the spindle and the hub there is a radial overlap. Since the spindle projects into the hub of the spur gear, the bearing required for mounting the spur gear can be accommodated inside the hub. Correspondingly, in a preferred further development an inner ring of at least one bearing by which the spur gear is mounted on the spindle is fixed on the spindle. Preferably, the inner ring is shrink-fitted onto the spindle. In particular, the inner ring is fixed so that it cannot move relative to the spindle. Correspondingly, an outer ring of the bearing is preferably fixed into the hub by expansion. In particular, the outer ring of the bearing is fixed so that it cannot move relative to the hub. In relation to reducing the axial fitting space of the transmission, the arrangement of the bearing inside the hub in accordance with this further development is advantageous.

Furthermore, the mounting of the planetary carrier offers further potential for reducing the axial fitting space of the transmission. Thus, in a preferred further development, no bearing is located axially between at least part of the planetary carrier and at least part of the spur gear. For an arrangement of the bearing in this area, fitting space would be needed, which may be dispensed with according to this further development.

As for the arrangement of the bearing, by means of which the planetary carrier is mounted, axially between at least part of the planetary carrier and at least part of the spur gear, according to a preferred further development at least part of the planetary carrier is arranged axially between each of the bearings with which the planetary carrier is mounted, and the spur gear. Thus, for each bearing with which the planetary carrier is mounted, at least part of the planetary carrier is arranged axially between that bearing and the spur gear. This means that the planetary carrier has a bearing on one side only. In that way the fitting space for a bearing on the second side of the planetary carrier is saved.

The sun gear has teeth that mesh with at least one planetary gearwheel of the planetary stage. In a preferred further development, some of those teeth form splines that mesh with teeth of the hub, by virtue of which the spur gear and the sun gear are connected rotationally fixed with one another. Since there is no separate spline array, the axial space occupied by the transmission is reduced further. Moreover production is simplified since the sun gear only has to be made with one set of teeth.

### BRIEF DESCRIPTION OF THE DRAWINGS

A preferred example embodiment of the invention is illustrated in the sole FIGURE, in which matching indexes denote similar or functionally equivalent features. In detail, the sole FIGURE shows a transmission with a planetary and a spur gear stage.

### DETAILED DESCRIPTION OF THE PREFERRED EMBODIMENTS

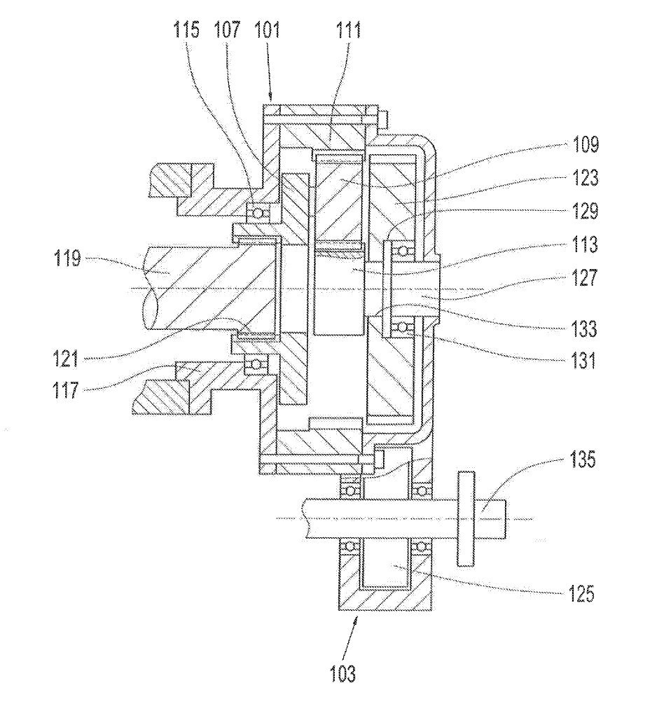

The transmission shown in FIG. 1 comprises a planetary stage 101 on the input side and a spur gear stage 103 on the output side. The planetary stage 101 comprises a planetary carrier 107, planetary gearwheels 109 mounted to rotate on the planetary carrier 107, a fixed ring gear 111 and a rotatable sun gear 113. The planetary gearwheels 109 mesh with the ring gear 111 and the sun gear 113.

By means of just one bearing 115, the planetary carrier 107 is mounted to rotate in a transmission housing 117. The ring gear 111 forms part of the transmission housing 117 and is bolted to other parts of the transmission housing 117. Relative to a flank of the planetary carrier 107, the bearing 115 is offset on the drive input side, i.e. in the direction of a drive input shaft 119.

By means of the drive input shaft 119, drive torque is exerted on the planetary carrier 107. For this purpose, the drive input shaft 119 is connected in a rotationally fixed manner to the planetary carrier 107 by splines 121.

The spur gear stage 103 comprises a first spur gear 123 and a second spur gear 125. The two spur gears 123, 125 are mounted to rotate and mesh with one another.

To mount the first spur gear 123 a spindle 127 is provided. This is screwed into the transmission housing 117. The first spur gear 123 forms a hub 129 into which a cylindrical part of the spindle 127 projects. By means of a bearing 131 the first spur gear 123 is mounted and can rotate on the spindle 127. Forces acting on the first spur gear 123 are in this way transmitted by way of the bearing 131 to the cylindrical part of the spindle 127.

By way of spline teeth 133 inside the hub 129, the first spur gear 123 is connected in a rotationally fixed manner to the sun gear 113.

The second spur gear 125 drives an output shaft 135. Correspondingly, there is a rotationally fixed connection between the second spur gear 125 and the output shaft 135.

In the transmission shown in FIG. 1 the planetary carrier 107, the planetary gearwheels 109, the ring gear 111, the sun gear 113 and the first spur gear 123 are each at least partially located in an axial intermediate space between the bearings 115, 131. This enables a reduction in the axial installation space.

### INDEXES

101 Planetary stage
103 Spur gear stage
107 Planetary carrier
109 Planetary gearwheel
111 Ring gear
113 Sun gear
115 Bearing
117 Transmission housing
119 Drive input shaft
121 Spline teeth
123 First spur gear
125 Second spur gear
127 Spindle
129 Hub
131 Bearing
133 Spline teeth
135 Output shaft

1-6. (canceled)

7. A transmission comprising:
at least one planetary stage (101),
at least one spur gear stage (103), and
a transmission housing (117);
the at least one planetary stage (101) comprising a planetary carrier (107) mounted to rotate, at least one planetary gearwheel (109) mounted to rotate on the planetary carrier (107) and a rotatable sun gear (113);
the spur gear stage (103) comprising at least one spur gear (123);
the at least one spur gear (123) and the sun gear (113) are connected to one another in a rotationally fixed manner;
the transmission housing (117) has at least one spindle (127); and
the spur gear (123) is mounted on the spindle (127).

8. The transmission according to claim 7, wherein the spur gear (123) forms a hub (129), and the spindle (127) at least partially projects into the hub (129).

9. The transmission according to claim 8, wherein the spur gear (123) is mounted on the spindle (127) by at least one bearing (131); and
an inner ring of the bearing (131) is fixed on the spindle (127) while an outer ring of the bearing (131) is fixed in the hub (129).

10. The transmission according to claim 7, wherein no bearing, by which the planetary carrier (107) is mounted, is arranged axially between at least part of the planetary carrier (107) and at least part of the spur gear (123).

11. The transmission according to claim 7, wherein at least part of the planetary carrier (107) is arranged between each of the bearings by which the planetary carrier (107) and the spur gear (123) are mounted.

12. The transmission according to claim 7, wherein teeth of the sun gear (113) form a spline fit (133) with teeth of the hub (129); and
the spur gear (123) and the sun gear (113) are connected with one another in a rotationally fixed manner by virtue of the spline fit.

13. A transmission comprising:
at least one planetary stage;
at least one spur gear stage; and
a transmission housing;
the at least one planetary stage and the at least one spur gear stage being coaxially aligned along a rotational axis;
the at least one planetary stage comprising a rotatable sun gear, a rotatable planetary carrier, and at least one planetary gearwheel that is rotatably supported on the planetary carrier;
the at least one spur gear stage comprising at least one spur gear;
the spur gear and the sun gear being connected to one another in a rotationally fixed manner such that the spur gear and the sun gear rotate in unison with one another; and
the transmission housing having at least one spindle, and the spur gear being rotatably supported on the spindle.

14. The transmission according to claim 13, wherein the spindle is rotationally fixed to the transmission housing, the spur gear has an aperture, and the spindle is partially received within the aperture of the spur gear.

15. The transmission according to claim 14, wherein the spur gear is rotatably supported on the spindle via a first bearing, and the first bearing comprises an inner ring that is fixed on the spindle and an outer ring that is fixed to the spur gear within the aperture.

16. The transmission according to claim 15, wherein the planetary carrier is rotatably supported, via a second bearing, by the transmission housing, and the planetary carrier has a cavity with radially inner splines;
a drive input shaft is received within the cavity and has radially outer splines that mesh with the inner splines of the planetary carrier such that the drive input shaft rotationally drives the planetary carrier; and
along the rotational axis between the first and the second bearings, the transmission is free of any further bearings.

17. The transmission according to claim 16, wherein the planetary gearwheel is axially located on a side of the planet carrier opposite the second bearing and the drive input shaft and is axially adjacent the first spur gear on a side of the first spur gear opposite the spindle and the second bearing.

18. A transmission comprising:
a planetary stage;
a spur gear stage; and
a transmission housing;
the planetary stage and the spur gear stage being coaxially aligned with one another along a rotational axis;
the planetary stage comprising a fixed ring gear, a rotatable sun gear, a rotatable planetary carrier, and at least one planetary gearwheel that is rotatably supported on the planetary carrier;
the spur gear stage comprising at least one spur gear;
the spur gear and the sun gear being connected to one another in a rotationally fixed manner such that the spur gear and the sun gear rotate in unison with one another; and
the transmission housing having at least one spindle, and the spur gear being rotatably supported on the spindle.
